(19) United States
(12) Patent Application Publication
(10) Pub. No.: US 2022/0228434 A1
(43) Pub. Date: Jul. 21, 2022

(54) INSECT SCREEN FOR BOATS

(71) Applicant: Vincenzo AVANZOLINI, Latina (IT)

(72) Inventor: Vincenzo AVANZOLINI, Latina (IT)

(21) Appl. No.: 17/569,264

(22) Filed: Jan. 5, 2022

(30) Foreign Application Priority Data
Jan. 18, 2021 (IT) 102021000000821

(51) Int. Cl. E06B 9/52

(52) U.S. Cl. CPC E06B 9/52; E06B 2009/527

(57) ABSTRACT

An insect screen for boats, particularly for portholes and manholes, has a rigid frame that supports a rigid mesh and embeds an opposite pair of plate-like lobes that jut out from its internal edge and are provided with through holes crossed by respective bars that slide and revolve relative to the holes. Each bar is provided at one end with a hooked end section, folded at right angle, whereas the other end is associated with a knob that is subject to the thrust of a helical spring externally inserted on each bar in intermediate position between the knob and the lobes.

### CROSS-REFERENCE TO RELATED APPLICATIONS

Not applicable.

### BACKGROUND OF THE INVENTION

### 1. Field of the Invention

The present invention relates to an insect screen for boats applicable to both portholes and manholes.

### 2. Description of Related Art Including Information Disclosed Under 37 CFR 1.97 and 37 CFR 1.98

In order to better appreciate the innovative features of the insect screen according to the invention, both as regards its structural configuration and its practicality of assembly/disassembly, this description continues by illustrating the composition and the installation of the different models of insect screen according to the prior art.

A first type of insect screen consists of a densely perforated flexible sheet, which is suitably shaped and sized in such a way to cover the opening of a porthole or a manhole.

Said sheet may consist of a thin plastic sheet, which has self-supporting capacities, or of a mesh fabric, which is supported perimetrically by a semi-rigid frame, which allows said mesh fabric to assume and maintain an extended planar position.

Said frame consists mostly of a bent steel wire, like the one that is used in the car sunshades that are fixed to the windows of the car doors.

The installation of such models of insect screens is carried out by means of fixing means that must not compromise the integrity of the frame and, secondly, that are capable of ensuring the easy and quick removal of the insect screen.

One of the most common fixing solutions is to connect the perforated sheet to the glass of the frame by means of strings that are fastened to the center of the glass, by means of suction cups or magnets, on one side and to the center of the perforated sheet on the other side.

After opening the hatch of the portlight towards the outside of the boat and after positioning the perforated sheet close to the opening to be covered, the user simply needs to tension the strings in such a way to move the sheet forwards until it goes into contact with the frame of the portlight with an adequate pressure to guarantee a seal along the entire perimeter of the frame.

It is precisely at this stage that the flexibility of said sheet is exploited, as its perimeter edge is disposed against the frame of the portlight, whereas its central portion tends to expand towards the opening defined by said frame.

Another type of insect screen for portholes or manholes consists of a fine mesh fabric, which is shaped like a soft sack and is suitably dimensioned to accommodate the lath of the frame in open position, whereas its opening is suitable for being tightly fixed all around the frame by means of suction cups or double-sided adhesive tapes or adhesive strips.

The two aforementioned types of insect screens and, in any case, all the models of insect screens for boats that are currently available on the market are impaired by the following drawbacks or functional limits.

The first defect consists in the poor practicality of assembly/disassembly, which is associated with a poor reliability of adherence to the frame, resulting in easy access for insects other than mosquitoes, flies, bees or spiders, which are provided with scratching or sharp claws, such as earwigs or scorpions.

Moreover, said insect screens of the prior art do not offer any resistance against the intrusion of rats, a circumstance that is quite frequently encountered while the boat is anchored in the port.

U.S. Pat. No. 1,648,445A discloses a port light of a boat comprising a tubular portion that defines an opening and a screen or mosquito net applied in the opening. The central tubular portion has two annular grooves disposed in side-by-side position, wherein elastic rings are applied to retain the screen or the net disposed between the two elastic rings. In order to install the screen or net in the central tubular portion, firstly the user must insert one of the two elastic rings, then the screen or net must be inserted until it is brought in contact with the elastic ring, and then the other elastic ring is applied, in such a way that the two elastic rings can retain the screen or net in intermediate position. In view of the above, the installation of the screen or net provides for multiple operating steps that convert the installation into a time-consuming complicated operation.

U.S. Pat. No. 1,364,695A discloses a port screen comprising an annular rim having an interned flange that acts as stop when the screen is inserted in the opening of the port, and an outpressed annular bead adapted to contact with the interior surface of a porthole frame to prevent and limit the outward displacement of the screen in the opening of the port. Therefore the screen is fixed inside the port by means of interference and its insertion/removal from the port is a difficult operation because the user must apply a sufficient force to overcome the friction resistance of the annular bead on the internal surface of the porthole frame.

GB131480A discloses a screen for the porthole lights of ships. The screen comprises an external rigid annular rim that supports a net. The screen or net comprises a fixed pin suitable for being inserted in a first hole obtained on the frame of the porthole and a movable pin suitable for being inserted in a second hole obtained on the frame of the porthole.

In order to install the screen or net it is necessary to hold the second pin in retracted position, in such a way that it does not protrude with respect to the rigid annular rim, insert the screen in the opening of the porthole in a slightly inclined position, insert the fixed pin in the first hole and finally insert the movable pin in the second hole.

DE102016004619A1 discloses a shielding device or insect gauze for portholes that is laterally covered with an intelligent foam material which adapts to the opening of the porthole wherein the shielding device is to be installed.

NL48478C discloses an insect net suitable for being inserted in an opening of portholes of ships. The insect net comprises a supporting frame with a raised rim that is tightly inserted in an internal surface of the porthole.

U.S. Pat. No. 2,204,761A discloses a window screen comprising a metallic frame suitable for being applied in a window opening. Engaging flanges are provided on the window.

The screen also comprises latching means suitable for cooperating with the engaging flanges to secure the screen to the window.

Each latching means comprises:
a plate that slides along a plane parallel to the plane where the screen lies; the plate can slide between a retracted position, wherein said plate does not protrude or protrude slightly from the frame, and an extracted position, wherein it considerably protrudes from the frame, in such a way to be coupled with the respective engaging flange;
a boxlike grip forming member, disposed in front of the screen and protruding inside the metallic frame, coupled with the plate and suitably configured to be held by the user in order to move the plate;
a helical spring partially disposed inside the boxlike element and provided with a first end connected to the boxlike element, and a second end connected to the metallic frame and exerting a traction force in such a way to constantly move the boxlike element closer to the frame, thus positioning the slidable plate in the extracted position.

The plate can be disposed in its retracted position by a user, holding the grip forming element and pulling it towards the center of the screen with a force sufficient to overcome the resistance offered by the spring.

Although such a window screen can be installed and uninstalled into/from the opening of the window as many times as necessary, such an operation is quite difficult to be performed by a single operator.

### BRIEF SUMMARY OF THE INVENTION

The present invention is the result of a critical observation of the drawbacks and limitations that impair the models of insect screens for boats that are currently available on the market. Moreover, the purpose of the present invention is to provide a new type of insect screen for portholes or manholes, which is characterized by maximum reliability, with reference to its tight adherence against the window frame, and by maximum resistance against the intrusion of insects and animals, including rats, but also cats or birds.

A further purpose of the present invention is to realize a model of insect screen for portholes or manholes that can be installed without minimally damaging the structural integrity of the window frame or of the wall housing said frame.

Last but not least, the purpose of the present invention is to realize a model of insect screen for portholes or manholes, whose installation and removal are so simple and fast that they do not require the use of skilled workers or of any tool or equipment for assembly and disassembly.

All of the aforesaid objectives have been achieved by the insect screen according to the invention, the main features of which are pointed out in the attached independent claim 1.

Advantageous embodiments appear from the dependent claims.

### BRIEF DESCRIPTION OF THE SEVERAL VIEWS OF THE DRAWINGS

For explanatory clarity the description of the insect screen according to the invention continues with reference to the accompanying drawings, which are shown only for illustrative, not limiting purposes, wherein:

FIG. 1 is a schematic axonometric view of the insect screen for boats according to the invention.

FIG. 2 is a sectional view of the insect screen of FIG. 1 taken along the plane II-II of FIG. 1.

FIG. 3 is a schematic axonometric view of a porthole of a boat suitable for being covered with the insect screen of FIG. 1.

FIG. 4 is a view of the insect screen of the invention applied to a porthole and seen from outside the boat.

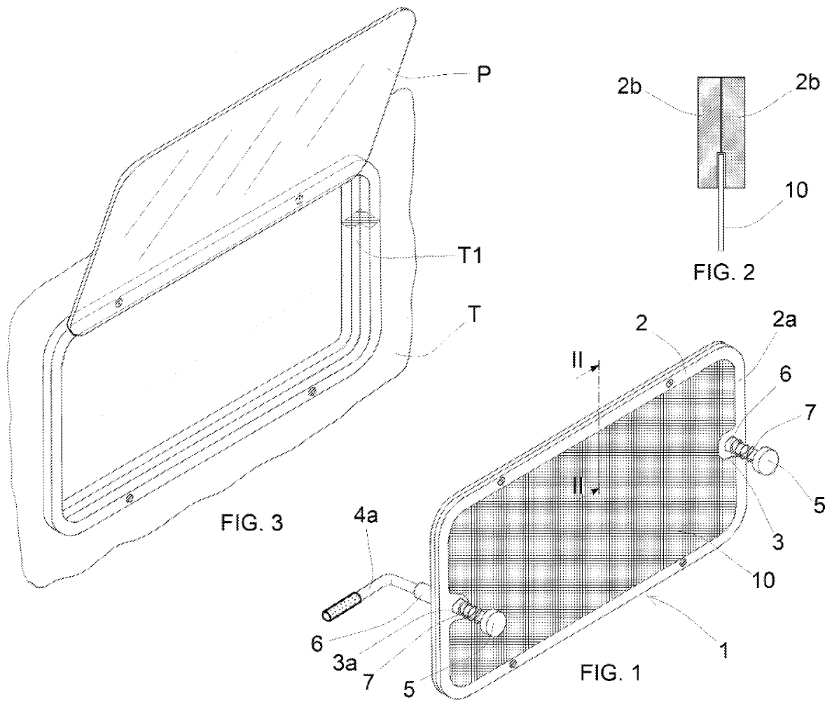

### DETAILED DESCRIPTION OF THE INVENTION

With reference to the aforesaid figures, the insect screen (1) according to the invention comprises a supporting frame, consisting of a frame (2) made of a rigid material, preferably a metal material, having the same shape as the porthole or manhole to which it is to be fitted.

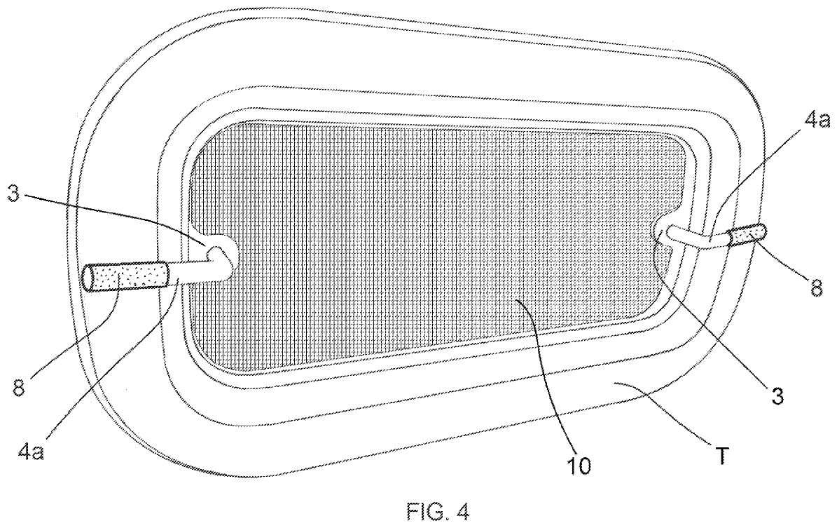

More precisely, said frame (2) has the same dimensions as the hatch (P) of the frame, in such a way that, after opening the hatch, said frame (2) can be perfectly embedded inside the frame (T) and fixed against the flat annular rim (T1) of the frame, which is suitable for acting as a watertight stop surface of the hatch (P), in closing position, as shown in FIG. 4.

Said frame (2) acts as a support for a rigid fine mesh (10) suitable for preventing the passage of small insects, such as mosquitoes, flies, midges, bees and the like; said rigid mesh (10) is woven with a stainless steel wire, preferably with a diameter of 0.6 mm, and in any case having a sufficient strength to prevent the intrusion of larger animals, such as rats, stray cats and birds.

Such a frame (2) is provided with an opposite pair of plate-like lobes (3) that protrude from its inner edge (2a) and are provided with respective through holes (3a).

A bar with circular section (4) is slidingly and revolvingly inserted into each one of said holes (3a), said bar (4) ending at one end with a hooked section (4a), bent at a right angle, whereas its other end is associated with a knob (5) that facilitates the easy operation of said bar (4), either to make it translate or rotate, in opposite direction, within said hole (3a).

In the preferred embodiment of the insect screen (1) according to the invention—in order to facilitate the alternate rotations and translations of said bar (4) with respect to the frame (2)—said bar (4) is coupled with a respective housing and guide bushing (6), which is in turn fixed in correspondence with said through holes (3a).

A helical spring (7) is inserted in said bar (4) and is interposed between said knob (5) and said lobes (3), with the task of contrasting the travels of said bar (4) in the direction that corresponds to an approaching movement of the knob (5) relative to the mesh (10) and, consequently, exerting a recall force on the bar when the bar is forcedly pushed along a travel in the aforementioned direction.

Finally, it should be pointed out that said frame (2) preferably comprises a pair of identical frames (2a) that are specularly opposed and fixed to each other, thus tightening the perimeter edge of said rigid mesh (10).

This description continues by illustrating the assembling/disassembling modes of the insect screen (1) according to the invention.

After opening the hatch (P) of the porthole or manhole, the frame (2) must be centered and positioned in the same housing of the frame (T) where the hatch (P) is accommodated in closed position.

During such a maneuver, the hooked end sections (4a) of the bars (4) must be directed towards the center of the mesh (10) or, in any case, in such a way as not to protrude from the frame (2), so as not to interfere with the edges of the frame (T) and hinder a quick easy centering of the frame (2).

Once the frame (2) has been correctly positioned in the housing of the frame (T), the operator simply needs to grab the knobs (5) in order to impose a travel towards the mesh (10) and a rotation of approximately 180° on the bars (4) in order to overturn the position of said hooked end section (4a) until it protrudes from the frame (2).

Once such a maneuver has been completed, the user simply needs to release the knobs (5) to automatically secure the insect screen (1) to the frame (T) because of the fastening action exerted by said hooked end sections (4a) towards the external side of said frame (T), as shown in FIG. 4, which shows that said hooked end section (4a) is preferably covered by a sheath (8), made of a soft anti-scratch material, in order to avoid damaging the surface finish of the external side of the frame (T).

Lastly, it should be pointed out that the return action of the springs (7) guarantees a safe stable fixing of the insect screen (1) by means of said hooked end sections (4a) on one hand, and a perfect adherence, under pressure, of the frame (2) to the flat annular rim (T1) of the frame (T) that acts as a watertight stop surface of the hatch (P), in closing position.

It is easy to understand that the insect screen (1) can be removed from the frame by simply and rapidly carrying out the aforesaid maneuver in reverse order.

I claim:

1. Insect screen for boats, particularly for portholes or manholes, comprising a frame and a watertight hatch, characterized in that it comprises:
a frame made of a rigid material, having the same shape and size as the hatch and embedding an opposite pair of plate-like lobes that jut out from its internal edge and are provided with through holes;
a rigid fine mesh with perimeter edges fixed to the frame;
two identical bars with circular section that are inserted in said holes with the possibility of sliding and revolving relative to said holes; each bar being provided at one end with a hooked end section folded at right angle, whereas the other end is associated with a knob; and
a helical spring that is externally inserted on each bar in intermediate position between said knob and said lobes in order to oppose the travels of said bar in the direction that corresponds to a movement of the knob towards the mesh.

2. The insect screen of claim 1, wherein said frame comprises a pair of identical frames that are disposed in specular opposite position and are fixed together in order to tighten the perimeter edge of said rigid mesh in intermediate position.

3. The insect screen of claim 1, wherein each bar is coupled with a housing and guiding bush fixed in said through holes.

4. The insect screen of claim 1, wherein said rigid mesh is woven with a stainless-steel wire.

5. The insect screen of claim 1, wherein said hooked end section of said bars is coated with a sheath made of a soft anti-scratch material.
